(19) United States
(12) Patent Application Publication
(10) Pub. No.: US 2022/0099245 A1
(43) Pub. Date: Mar. 31, 2022

(54) MAGNETIC ACCESSORY SURFACE MOUNT

(71) Applicant: BOTE, LLC, Fort Walton Beach, FL (US)

(72) Inventor: Corey COOPER, Fort Walton Beach, FL (US)

(73) Assignee: BOTE, LLC, Fort Walton Beach, FL (US)

(21) Appl. No.: 17/033,067

(22) Filed: Sep. 25, 2020

(51) Int. Cl. F16M 13/02; B63B 32/70; H01F 7/02

(52) U.S. Cl. CPC F16M 13/02; H01F 7/0252; B63B 32/70

(57) ABSTRACT

Magnetic accessory surface mounts are provided using magnetic attraction between the ferrous metal accessories and a magnet disposed on, or in, the surface on which the accessories are to be mounted. Magnetic mounts are particularly suitable for stand up paddleboards, and other sea craft that have a very low profile. A magnet is disposed on the deck of the stand up paddleboard, and magnetically couples an accessory or a drink holder to the deck, for easy access by the user. The magnet is covered with a patch made of waterproof PVC to both strengthen the permanent connection of the magnet to the deck and to protect the magnet from water.

### BACKGROUND OF THE INVENTION

### 1. Field of the Invention

The present invention relates generally to devices and methods for holding accessories to the surface of sports equipment, such as stand up paddleboards, known as “SUPs,” where in the regular course of activity, items desirably positioned near the user on the upper surface are subjected to wave, water, and motion which tends to knock such items off the upper surface. The invention includes magnetically coupling the items to the sports equipment by placing magnets on or just below the upper surface.

### 2. Description of the Related Art

For a wide variety of water and land vehicles, e.g., boats, automobiles, trucks, and all-terrain vehicles (ATVs), significant surrounding structures provide many opportunities to mount drink holders and other devices for holding a variety of accessories. For boats, drink holders can be hung on lifelines or mounted on wheel steering pedestals, or otherwise supported on vertical structures. Accessories like tools, flashlights, cameras, knives and other items can be stored in lazarettes, lockers, glove boxes and other structures which enclose the accessories.

Adventurers who use kayaks, canoes, rowboats and other open deck watercraft often store accessories in containers placed under seats or simply placed rested on the floor of the watercraft. Fetching the accessories does not present an appreciable problem: the adventurer can simply stop paddling or rowing, reach for the container, extract the accessory and use at will. Drinks kept in coolers, as well as accessories, are easily accessed because the adventurer uses the watercraft in a sitting position. Similarly, boats, ATVs and other land vehicles have bulk and vertical structures that keep accessories from being lost or ejected from movement of the boat or vehicle.

Stand up paddleboards, or SUP's, have become popular because of many factors, not the least of which include the inexpensive nature of ownership, storage and maintenance. This is particularly true of inflatable SUPs which can be rolled up and stored in a very small space, and then inflated after carried in an automobile, or in a backpack or carry bag, to the place of intended use. SUPs also provide exercise, by having the use stand on the upper surface and paddle with a single, relatively long-handled paddle. Paddling a SUP uniquely works out a wide range of muscles in the legs, arms, back, stomach and shoulders. While obtaining a high degree of exercise, the user is also experiencing locomotion, traveling from one point of interest to another, thereby achieving a recreational goal while simultaneously exercising.

Unlike boats, a SUP does not have storage space for accessories or coolers, nor do they have vertical structures for hanging or otherwise mounting a drink holder. Accessories such as pocketknives, sunglasses, and drinks are awkward to deal with because a SUP is essentially a two-dimensional structure which, when deployed in water, presents only a relatively flat deck or upper surface on which the user stands. Any item placed on the deck will easily slide off because of motion, or wash overboard when water breaches the surface, as naturally happens when the SUP is in motion.

Drink holders for SUPs are generally known. One known type uses a suction cup to stick a drink holder to the deck of a SUP. A user of places a drink in the drink holder, and as long as the suction cup maintains a grip, the drink is available to the user by bending over and grabbing the drink from the drink holder.

One problem with suction cup-type drink holders is that the suction can be easily disrupted when the drink holder is jarred, or when the wetted upper surface of the SUP facilitates sliding of the suction cup away from the initial point of fixture. Further, suction cups require a perfectly flat surface to make a good connection, such that suction cups for SUPs with textured surfaces, which prevent the user from slipping while paddling, will not work to a reliable degree.

Another type of known drink holder for SUPs involves the use of Velcro (complementary micro-hooks and micro-loops) where a patch of material is glued to the surface of the SUP, and the complementary material is glued to the bottom surface of the drink holder. The problem with this type of drink holder is that the glued surfaces are exposed to water, and will weaken over time. Moreover, there is a tendency for the micro-structures to become less connective as they accumulate particulate debris such as algae and other aquatic plant life.

A problem associated with both types of drink holders mentioned above is that neither of them are capable of holding in a stable manner accessories other than drinks. For example, if a pocketknife is placed in a drink holder, it can bounce or wash out with relatively little motion. Thus, it would not be recommended for a drink holder, held to the surface with Velcro or suction cups, to hold anything but a canned or bottled drink.

A continuing need exists for an improved way of holding drinks and accessories on a flat surface, such as that of the deck of a SUP.

### SUMMARY OF THE INVENTION

In one aspect of the present invention, an apparatus for detachably coupling an accessory to a flat surface includes a magnet adapted to be placed in a position on the flat surface, and a patch disposed over the magnet and being bonded to the flat surface to thereby encapsulate the magnet between the flat surface and the patch. As a result, accessories having a ferrous metal component are detachably coupled to the flat surface when brought within the influence of a magnetic field generated by the magnet.

Preferably, the flat surface is the deck or upper surface of a stand up paddleboard (SUP) and the magnet is permanently bonded, adhesively or thermally, or other suitable means for permanent bonding, to the upper surface at a position selected to allow the user easy access. The preferred position is forward of where the user stands and approximately along the longitudinal centerline of the SUP. A user can simply bend over without repositioning a stance to grab accessories. The magnetic force binding the accessory to the magnet is of such flux density to allow extraction with a few foot-pounds of energy, enough to stay attached through normal operation of the SUP (where water rushes over the deck, the deck pitches, rolls and yaws, and slight to medium bumps of the accessory with a paddle, foot, hand or debris floating in the water will not easily dislodge the accessory.

Preferably, the magnet has a residual flux density (Br) of 14.5 to 14.8 KGs, a coercive force (Hc) of >11.2 KOe and a maximum energy product (BHmax) of 49.5 to 52 MGOe. Magnets of different properties can be used, so long as the goal of forming a detachable binding of accessories to the SUP is achieved. This means that the magnet should be strong enough to resist disruption and unintentional forces, such as when the accessory encounters an onrush of water, a violet pitch, roll or yaw motion of the SUP, or slight bumps of the accessory with a paddle, debris in water or the foot or hands of a user. Forces of up to a few foot-pounds of energy should be required to remove the accessory from the board. This allows the user to reach down a grab an accessary and remove it from the board with relative ease, but at the same time, inadvertent and unintentional forces, which might otherwise remove the accessory, are resisted. The user can maintain momentum on the board, without having to stop to use both hands or reposition himself on the board to extract an accessory from a holding mechanism.

The invention contemplates the magnetic coupling for accessories to be either a retrofit kit for existing SUPS, boards, surfers, etc., or pre-installed at the factory. Preferably, the magnetic coupling is pre-installed to ensure favorable bonding and to preserve the graphics on the deck. Preferably, the placement of the magnet is done in coordination with the SUP graphics so that it blends into the overall surface design.

As a kit, the magnetic coupling would include a magnet, a patch, and a supply of glue, with instructions on where to place the magnet and how to attach the magnet, such as by first location a place on the SUP for a desired location, then applying glue to one side of the magnet and placing the glued magnet in the selected location. After the glue as dried, the next step is the apply glue to the periphery of the patch and then place the patch over the magnet, ensuring that the outer edge of the patch completely encapsulates the magnet between the upper surface of the SUP and the patch. This encapsulation ensures that the magnet is not exposed to water.

Preferably, the apparatus may further include a layer of EVA foam traction material. In addition to providing traction for the user while standing and paddling on the board, the EVA foam layer further enhances the connection of the magnet to the SUP, and provides a more or less flush surface, rather than a simple “bump” where the magnet is mounted. The flush surface assists in the magnetic detachable connection of accessories to the SUP.

In another aspect of the present invention, a stand up paddle board (SUP) or similar kayak or comparable sea craft, such as a kayak, surfboard, windsurfer and the like, includes an inflatable body made of drop stitch fabric and including an upper surface, at least one magnet bonded to the upper surface of the body, whereby the at least one magnet is capable of detachably coupling to an accessory having a ferrous metal component. Any type of accessory is capable of being detachably coupled to the flat surface of the sea craft when brought within the influence of a magnetic field generated by the magnet.

The invention further includes the combination of a sea craft, such as an inflatable stand up paddleboard, a magnet, and a drink holder having a ferrous metal component which detachably couples the drink holder to the upper surface of the sea craft.

A further aspect of the invention is to provide a drink holder and means for magnetically coupling the drink holder to the deck or upper surface of a sea craft, such as a stand up paddleboard. The drink holder includes a magnet that is capable of being connected permanently to the upper surface so that the drink hold can be magnetically couple to the sea craft through the magnetic force generated by the magnet.

Other aspects of the invention will become apparent in view of the following detailed description and claims.

### BRIEF DESCRIPTION OF THE DRAWINGS

FIG. 1 is a top view of a typical stand up paddleboard (SUP) having a magnet disposed in the upper surface or deck of the SUP, according to a preferred embodiment of the invention;

FIG. 2 is side view of the SUP shown in FIG. 1;

FIG. 3 is an enlarged longitudinal cross-sectional view of the SUP of FIGS. 1 and 2, taken at the location of the magnet;

FIG. 4 is an enlarged top view of the SUP of FIGS. 1 and 2, taken above the magnet;

FIG. 5 is an exploded view of FIG. 4, showing the placement of the magnet between the covering patch and the upper surface of the SUP;

FIG. 6 is a side elevational view of a combination magnet, drink holder and sea craft, taken along line V-V of FIG. 5, according to a preferred embodiment of the present invention; and

FIG. 7 is a cross-sectional view taken along line VI-VI of FIG. 6.

### DETAILED DESCRIPTION OF THE INVENTION

The present invention is described below with reference to an inflatable stand up paddleboard (SUP), as the present invention is particularly suitable for such inflatable structures that are typically made of drop stitch fabric, which is well known in the art. Using drop stitch fabric, a SUP is made to include an upper surface, which acts as a deck, and a lower surface, which forms the bottom. The thickness of a typical SUP is typically a few inches and thus the side surfaces of the SUP form what amounts to what would be “freeboard” on a boat. When a user stands on the SUP, the freeboard aspect is pushed down by the weight of the user so as to present a diminished profile, such that the SUP takes on a near two-dimensional appearance, which no vertical structures to support accessories. Drop stich fabric, having yarns extending between upper and lower sheets of material, allow for inflation at pressures much greater pressures, thus imparting a physical strength and hardness comparable to solid SUPs or surfboards.

Further, while the present invention is described in detail with reference to inflatable SUPs, other types of aquatic sport structures can benefit from the present invention, including inflatable and/or solid wind surfers, kayaks, surf boards and other structures that essentially present a low to non-existing side profile.

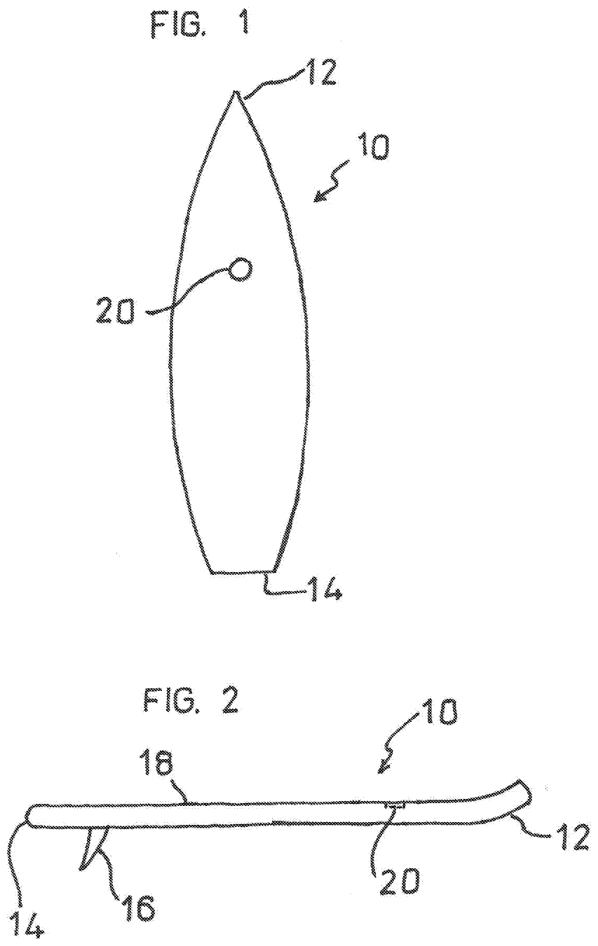

Referring now to FIGS. 1 and 2, an inflatable SUP 10 has a bow 12, a stern 14, a skeg 16 and an upper surface 18 that acts as a deck on which a user stands while paddling from a standing position. A magnet 20 is capable of detachably coupling an accessory (not shown in FIGS. 1 and 2) to the relatively flat upper surface 18 of the SUP 10. The magnet 20 is also adapted to be placed in a position on the upper surface 18 that is preferably near or at the centerline of the SUP 10, and forward of where the user would typically stand while paddling. This allows the user to access accessories coupled to the magnet, without having to shift positions on the SUP 10, although off center positions would also be acceptable, meaning towards the starboard or port side of the SUP 10.

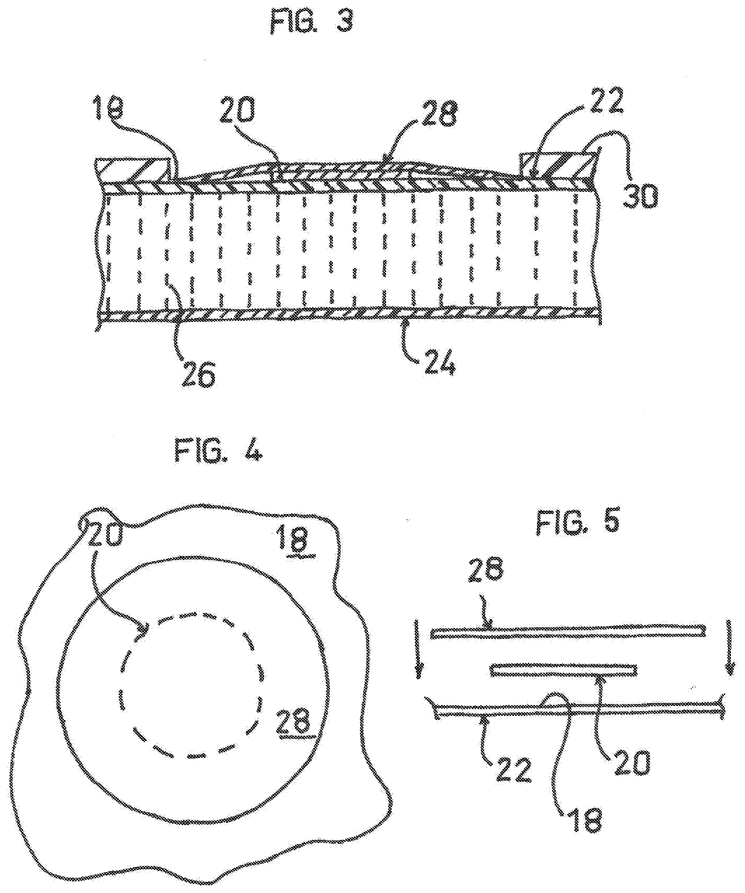

Details of how the magnet 20 is attached to the upper surface 18 are shown in FIGS. 3-5, which represents an enlarged longitudinal, sectional view of the SUP through the magnet 20. In typical fashion, the SUP is made of an upper sheet 22 of PVC fabric and a lower sheet 24 of PVC fabric 24, bound together by multiple strands or yarns 26, shown schematically as parallel broken lines. The upper surface 18 of the SUP 10 can be the upper surface of the upper sheet 2 although multiple layers of material can be added to strengthen the SUP. For simplicity of illustration, the SUP 10 used for illustrative purposes has only a single sheet of material for the upper and lower portions of the SUP.

The magnet 20 is preferably glued or otherwise adhesively bonded to the upper surface of the SUP 10, which is the upper surface of the upper sheet 22, using any known and suitable adhesive materials or thermal bonding techniques. A cover or patch 28, preferably made of PVC fabric material, is adhesively bonded to the upper surface 18 to encase the magnet 20 in a watertight chamber. The magnet 20 is preferably a rare earth two-inch diameter disc. It is preferred to use the strongest magnet available for a limited amount of space. For that purpose, rare earth magnets, and particularly, neodymium magnets are preferred. These are permanent magnets made from an alloy of neodymium, iron and boron to form the Nd₂Fe₁₄B tetragonal crystalline structure. These are commercially available from a variety of sources, and are widely considered the strongest type of permanent magnets available commercially.

As seen in FIG. 3, the apparatus may further include a layer 30 of EVA foam traction material. In addition to providing traction for the user while standing and paddling on the board, the layer further enhances the connection of the magnet to the SUP, and provides a more or less flush surface, rather than a simple “bump” where the magnet is mounted. The flush surface assists in the magnetic detachable connection of accessories to the SUP. Also, the layer 30 of foam traction material is bonded to the upper surface of the SUP and has an opening centered on the magnet 20 to render the upper surface substantially flat, with the top of the magnet and covering patch flush with the upper surface of the traction material.

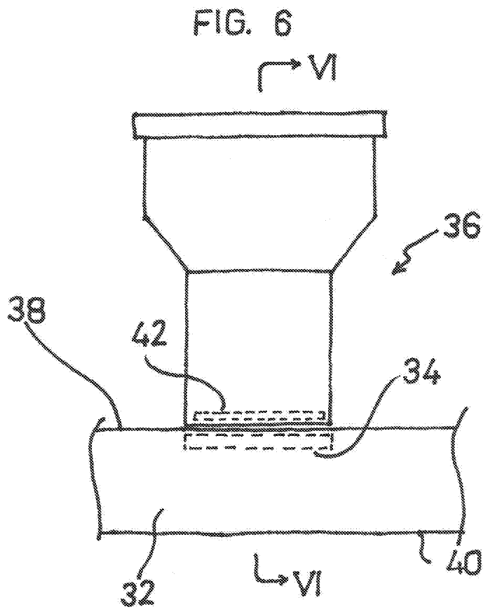

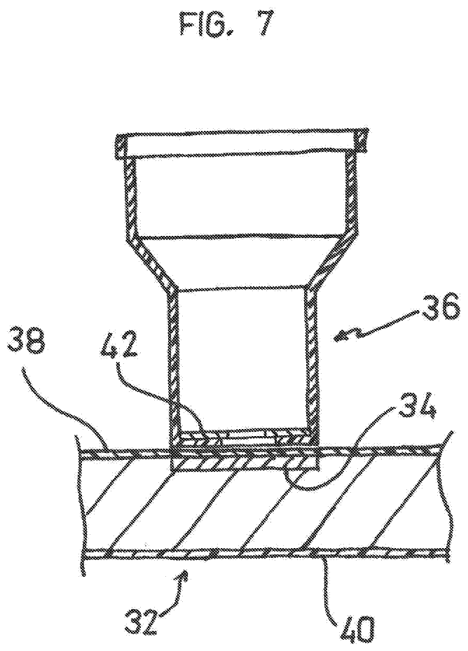

As seen in FIGS. 6 and 7, another aspect of the invention is the combination of a sea craft, such as a SUP 32, a magnet 34 disposed under the upper surface of the SUP 32, and a drink holder 36. As seen in FIGS. 6 and 7, in this case the SUP 32 is shown to be a solid structure, such as a fiberglass board having an outer layer of PVC material, defining an upper surface 38 and a lower surface 40, which defines respectively a deck on which to stand, and a bottom. Equally, the SUP could be inflatable drop stitch material, in which case the magnet would be glued, for example, to the upper surface and “patched” with a piece of PVC fabric lying over the magnet and bonded to the upper surface.

If the drink holder 36 is made of a thin ferrous metal, it will magnetically couple to the upper surface 38 of the SUP 32, preferably with a force that will resist relatively light disturbances, while being relatively easy to de-couple by hand whenever the user wants to remove the drink holder 36. The preferred shape of the drink holder is to define at least two tiers to accommodate canned or bottled drinks of different diameters, such as seven and twelve ounce cans and bottles.

If the drink holder 36 is made of plastic or non-ferrous metals, a ferrous metal plate 42 is adhesively bonded to or otherwise physically attached to the bottom of the drink holder 36. In this way, the drink holder 36 is magnetically coupled to the upper surface of the SUP 32. Both the bottom of the drink holder 36 and the metal plate 42 are provided with a centrally located hole to allow water to drain from the drink holder 36.

In use, the drink holder 36 holds a beverage, and the user can reach down and remove the beverage from the drink holder 36, in which case, the magnetic coupling remains unbroken. Alternatively, the user can remove the drink holder 36 containing the beverage, by reaching down and pulling the drink holder 36 with sufficient force to break the magnetic coupling. In either case, the drink holder 36 is a convenient place to hold a beverage and is easily accessible by the user. If the drink holder 36 is insulated, which the present invention contemplates as an alternative embodiment, it is preferred to remove the drink holder 36 when the user needs to have a drink.

The drink holder 36 can also serve as a holder of non-ferrous accessories, such as sunglasses, tubes of sunscreen, cell phones, video cameras and the like. Accessories that have ferrous metal components, such as pocketknives, tools, and the like, can be held in the drink holder 36 as well. The drink holder 36 may provide an extra measure of security from inadvertent dislodging, for such accessories. The drink holder 36 could also be provided with a lid and a tether strap, so that the user could be tethered to the drink holder 36 in case a large dislodging force de-couples the drink holder 36 from the SUP 32.

While the embodiments described herein include a magnet bonded to the deck of a stand up paddleboard, which magnetically attracts a ferrous metal component of an accessory or a drink holder, it is possible that the positions can be switched, such that a ferrous metal element is embedded in or connected to the deck, and a magnet is provided in the drink holder. Other accessories could be modified to include a magnet so that they too could be magnetically coupled to the deck.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. An apparatus for detachably coupling an accessory to a flat surface, comprising:
a magnet adapted to be placed in a position on the flat surface; and
a patch disposed over the magnet and being bonded to the flat surface to thereby encapsulate the magnet between the flat surface and the patch,
whereby an accessory having a ferrous metal component is capable of being detachably coupled to the flat surface when brought within the influence of a magnetic field generated by the magnet.

2. The apparatus of claim 1, wherein the flat surface is an upper surface of an inflatable stand up paddleboard (SUP), and wherein the magnet is adhesively bonded to the upper surface, and the patch is adhesively bonded to the upper surface and sized to completely envelop the magnet when bonded to the upper surface.

3. The apparatus of claim 2, wherein the patch is made of PVC fabric material.

4. The apparatus of claim 2, wherein the magnet is preferably a rare earth permanent magnet.

5. The apparatus of claim 4, wherein the rare earth permanent magnet is made of a neodymium alloy.

6. The apparatus of claim 5, wherein the magnet field has a magnetic force capable of binding the accessory to the flat surface and has a flux density selected to allow extraction of the accessory by hand with a few foot-pounds of energy and to prevent de-coupling through normal operation of the SUP.

7. The apparatus of claim 1, further comprising a layer of foam traction material connected to the flat surface and having an opening centered on the magnet, thereby providing an approximately flush flat surface.

8. A sea craft comprising:
an inflatable body made of drop stitch fabric and including an upper surface; and
at least one magnet bonded to the upper surface of the body,
whereby an accessory having a ferrous metal component is capable of being detachably coupled to the upper surface when brought within the influence of a magnetic field generated by the magnet.

9. The sea craft of claim 8, wherein the sea craft is selected from the group consisting of a stand up paddleboard (SUP), a kayak, a surfboard and a windsurfer.

10. The sea craft of claim 8, further comprising a patch bonded to the upper surface over the magnet, thereby forming an encasement for the magnet.

11. The sea craft of claim 8, wherein the magnet is preferably a rare earth permanent magnet.

12. The sea craft of claim 11, wherein the rare earth permanent magnet is made of a neodymium alloy.

13. The sea craft of claim 11, wherein the magnet field has a magnetic force capable of binding the accessory to the flat surface with a force sufficient to allow extraction of the accessory by hand with a few foot-pounds of energy and to prevent de-coupling through normal operation of the sea craft.

14. A drink holder comprising:
a body having a ferrous metal property; and
a magnet, capable of being permanently attached to an upper surface of a sea craft,
wherein the magnet has a magnetic field of sufficient magnetic force to magnetically couple the drink holder to the upper surface of the sea craft.

15. The drink holder of claim 14, wherein the body is made of a ferrous metal.

16. The drink holder of claim 14, wherein the body includes an element made of a ferrous metal.

17. The drink holder of claim 14, further comprising a patch made of plastic material, and being capable of covering the magnet when the magnet is attached to the upper surface of the sea craft.

18. The drink holder of claim 14, wherein the magnet field has a magnetic force capable of binding the accessory to the flat surface and has a magnetic strength sufficiently weak to allow removal of the drink holder by hand with a few foot-pounds of energy, and sufficiently strong to prevent de-coupling through normal operation of the sea craft.
